(19) United States
(12) Patent Application Publication
(10) Pub. No.: US 2015/0005948 A1
(43) Pub. Date: Jan. 1, 2015

(54) ELECTRONIC DEVICE AND METHOD FOR CONTROLLING ROTATION SPEED OF FAN THEREOF

(71) Applicant: Hon Hai Precision Industry Co., Ltd., New Taipei (TW)

(72) Inventors: CHAO-KE WEI, New Taipei (TW); YAO-TING CHANG, New Taipei (TW)

(73) Assignee: HON HAI PRECISION INDUSTRY CO., LTD., New Taipei (TW)

(21) Appl. No.: 14/011,707

(22) Filed: Aug. 27, 2013

(30) Foreign Application Priority Data
Jun. 27, 2013 (TW) 102123085

(51) Int. Cl. G05B 13/02

(52) U.S. Cl. CPC G05B 13/02
USPC 700/275

(57) ABSTRACT

A method for controlling rotation speed of a fan is applied in an electronic device, which stores a standard work temperature value and a critical temperature value greater than the standard work temperature value. The method includes following steps. Periodically obtaining a temperature value of the electronic device, comparing the obtained temperature value with the standard work temperature value and the critical temperature value. If the obtained temperature value is less than the standard work temperature value, decreasing the rotation speed by a first preset value. If the obtained temperature value is greater than the standard work temperature value and less than the critical temperature value, increasing the rotation speed by a second preset value. If the obtained temperature value is greater than the critical temperature value, increasing the rotation speed by a third preset value. The third preset value is greater than the first and the preset values.

### CROSS-REFERENCE TO RELATED APPLICATION

This application is related to copending applications entitled, “ELECTRONIC DEVICE AND METHOD FOR CONTROLLING ROTATION SPEED OF FAN THEREOF”, filed **** (Atty. Docket No. US49331).

### BACKGROUND

1. Technical Field

The present disclosure relates to electronic devices, and particularly, to an electronic device capable of controlling the rotation speed of a fan of the electronic device and a related method.

2. Description of Related Art

A known server obtains the current temperature value T from an inner temperature sensor at a fixed time value, such as 2 seconds. When the current temperature value T is greater than a standard work temperature T0 of the server, the rotation speed of fans of the server needs to be increased. When the current temperature value T is not greater than the standard work temperature T0, the rotation speed of fans of the server needs to be decreased to save power. However, when the current temperature value T is far greater than the standard work temperature T0, the server may not be able to decrease the rotation speed of the fans quickly, which may cause the electronic device to be suddenly shut down or crash.

Therefore, there is a need to provide a means to overcome the above-described shortcomings.

### BRIEF DESCRIPTION OF THE DRAWINGS

Many aspects of the present disclosure should be better understood with reference to the following drawings. The emphasis is placed upon clearly illustrating the principles of the present disclosure.

FIG. 1 is a block diagram of an electronic device, in accordance with an exemplary embodiment.

FIG. 2 is a flowchart of a method for controlling rotation speed of a fan, in accordance with an exemplary embodiment.

### DETAILED DESCRIPTION

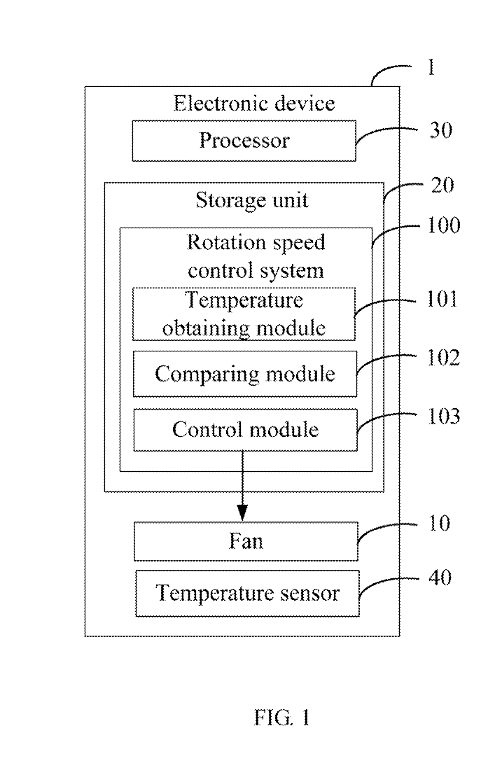

FIG. 1 illustrates an embodiment of an electronic device 1. The electronic device 1, which may be a computer or a tablet computer, includes at least one fan 10, a storage unit 20, a processor 30, and a temperature sensor 40. The temperature sensor 40 senses the temperature T of the electronic device 1. The storage unit 20 stores a standard work temperature value T1 of the electronic device 1 and a critical temperature value T2 which is greater than the standard work temperature value T1. When the temperature value T of the electronic device 1 is greater than the critical temperature value T2, the electronic device 1 may be suddenly shut down or crashed, accordingly, the rotation speed of the fan 10 needs to be increased quickly to decrease the temperature T of the electronic device 1 quickly. When the temperature value T of the electronic device 1 is less than the critical temperature value T2 and greater than the standard work temperature value T1, the rotation speed of the fan 10 will also be increased to prevent the electronic device 1 from being damaged. When the temperature value T of the electronic device 1 is less than the standard work temperature value T1, the rotation speed of the fan 10 needs to be decreased to save energy. The storage unit 20 further stores a rotation speed control system 100. The system 100 includes a variety of modules executed by the processor 30 to provide the functions of the system 100. The detail description of the system 100 will be provided below.

In the embodiment, the system 100 includes a temperature obtaining module 101, a comparing module 102, and a control module 103 which are collection of software instructions.

The temperature obtaining module 101 periodically obtains a temperature value T of the electronic device 1 sensed by the temperature sensor 40. In the embodiment, the temperature obtaining module 101 periodically obtains the temperature value T of the electronic device 1 when the electronic device 1 begins to run.

The comparing module 102 compares the obtained temperature value T with the standard work temperature value T1 and the critical temperature value T2 stored in the storage unit 20.

The control module 103 decreases the rotation speed of the fan 10 a first preset value when the obtained temperature value T is less than the standard work temperature value T1.

The control module 103 further increases the rotation speed of the fan 10 a second preset value when the obtained temperature value T is greater than the standard work temperature value T1 and less than the critical temperature value T2. In the embodiment, the first preset value is equal to the second preset value, such as 2% of the rotation speed for example. In an alternative embodiment, the first preset value may be different from the second preset value.

The control module 103 further increases the rotation speed of the fan 10 a third preset value when the obtained temperature value T is greater than the critical temperature value T2. The third preset value is greater than the first preset value and the second preset value.

With such configuration, when the temperature of the electronic device 1 is too high to cause the electronic device to be suddenly shut down or crash, the electronic device 1 adjusts the rotation speed of the fan 10 quickly.

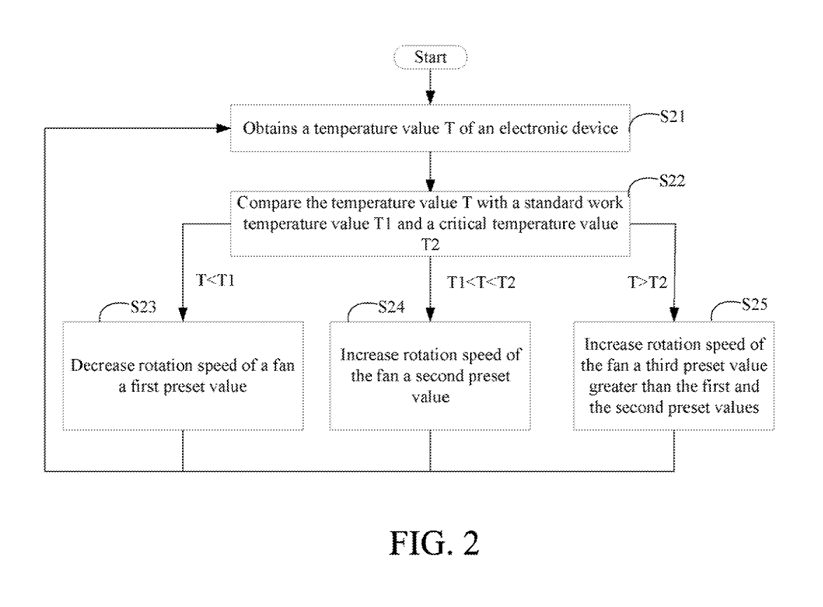

FIG. 2 is a flowchart of a method for controlling rotation speed of the fan 10, in accordance with an exemplary embodiment.

In step S21, the temperature obtaining module 101 periodically obtains a temperature value T of the electronic device 1 sensed by the temperature sensor 40.

In step S22, the comparing module 102 compares the obtained temperature value T with the standard working temperature value T1 and the critical temperature value T2 stored in the storage unit 20. If the obtained temperature value T is less than the standard working temperature value T1, the procedure goes to step S23. If the obtained temperature value T is greater than the standard working temperature value T1 and less than the critical temperature value T2, the procedure goes to step S24. If the obtained temperature value T is greater than the critical temperature value T2, the procedure goes to step S25.

In step S23, the control module 103 decreases the rotation speed of the fan 10 a first preset value.

In step S24, the control module 103 increases the rotation speed of the fan 10 a second preset value.

In step S25, the control module 103 increases the rotation speed of the fan 10 by a third preset value, and the third preset value is greater than the first preset value and the second preset value.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments.

What is claimed is:

1. An electronic device comprising:
at least one fan;
a temperature sensor;
a storage unit storing a plurality of modules, and a standard work temperature value of the electronic device and a critical temperature value greater than the standard work temperature value; and
a processor to execute the plurality of modules, wherein the plurality of modules comprises:
a temperature obtaining module to periodically obtain a temperature value of the electronic device sensed by the temperature sensor;
a comparing module to compare the obtained temperature value with the standard work temperature value and the critical temperature value stored in the storage unit; and
a control module to decrease a rotation speed of the fan by a first preset value when the obtained temperature value is less than the standard work temperature value, increase the rotation speed of the fan by a second preset value when the obtained temperature value is greater than the standard work temperature value and less than the critical temperature value, and increase the rotation speed of the fan by a third preset value when the obtained temperature value is greater than the critical temperature value, and the third preset value being greater than the first preset value and the second preset value.

2. The electronic device of claim 1, wherein the temperature obtaining module is configured to periodically obtain the temperature value of the electronic device when the electronic device begins to run.

3. The electronic device of claim 1, wherein the first preset value is equal to the second preset value.

4. The electronic device of claim 1, wherein the first preset value is different from the second preset value.

5. A method for controlling rotation speed of at least one fan applied in an electronic device, the electronic device comprising a temperature sensor, and a storage unit storing a standard work temperature value of the electronic device and a critical temperature value greater than the standard work temperature value, the method comprising:
periodically obtaining a temperature value of the electronic device sensed by the temperature sensor;
comparing the obtained temperature value with the standard work temperature value and the critical temperature value stored in the storage unit;
decreasing a rotation speed of the fan by a first preset value when the obtained temperature value is less than the standard work temperature value;
increasing the rotation speed of the fan by a second preset value when the obtained temperature value is greater than the standard work temperature value and less than the critical temperature value; and
increasing the rotation speed of the fan by a third preset value when the obtained temperature value is greater than the critical temperature value, and the third preset value being greater than the first preset value and the second preset value.

6. The method of claim 5, wherein the step periodically obtaining a temperature value of the electronic device sensed by the temperature sensor further comprises:
periodically obtaining a temperature value of the electronic device sensed by the temperature sensor when the electronic device begins to run.

7. The method of claim 5, wherein the first preset value is equal to the second preset value.

8. The method of claim 5, wherein the first preset value is different from the second preset value.
